(19) United States
(12) Patent Application Publication
(10) Pub. No.: US 2023/0289302 A1
(43) Pub. Date: Sep. 14, 2023

(54) MAXIMIZATION OF SPEEDS IN MIXED MEMORY MODULE CONFIGURATIONS

(71) Applicant: HEWLETT-PACKARD DEVELOPMENT COMPANY, L.P., Spring, TX (US)

(72) Inventors: Wen-Bin Lin, Taipei City (TW); Chao-Wen Cheng, Taipei City (TW); Cheng-Yi Yang, Taipei City (TW)

(21) Appl. No.: 17/691,365

(22) Filed: Mar. 10, 2022

(51) Int. Cl. G06F 13/16; G06F 9/4401

(52) U.S. Cl. CPC G06F 13/161; G06F 9/4406

(57) ABSTRACT

In example implementations, a computing device is provided. The computing device includes a memory bus, a first memory module connected to a first slot of the memory bus, a second memory module connected to a second slot of the memory bus, and a processor communicatively coupled to the memory bus. The processor is to detect a mixed memory module configuration caused by the first memory module and the second memory module and train the first memory module and the second memory module to operate at a maximum mixed memory module configuration speed.

### BACKGROUND

Computing devices can be used to execute various applications and programs. A processor is deployed in a computing device to execute the applications and programs. The computing device can have additional components that can help execute the applications, such as memory, graphics processors, and the like.

The computing device may include memory modules. The memory modules allocate memory to execute various applications on the computing device. The more memory the computing device has, the more applications the computing device can execute simultaneously. Different memory modules can execute at different speeds, which can affect the performance of the computing device.

### BRIEF DESCRIPTION OF THE DRAWINGS

FIG. 1 is a block diagram of an example computing device to maximize speeds in a mixed memory module configuration of the present disclosure;

FIG. 2 is another block diagram of another example computing device to maximize speeds in a mixed memory module configuration of the present disclosure;

FIG. 3 is a block diagram that illustrates different example configurations of memory modules in a memory bus of the computing device of the present disclosure;

FIG. 4 is a flow chart of an example method to maximize speed in a mixed memory module configuration of the present disclosure; and

FIG. 5 is an example non-transitory computer readable storage medium storing instructions executed by a processor to maximize speed in a mixed memory module configuration of the present disclosure.

### DETAILED DESCRIPTION

Examples described herein provide a computing device and method to maximize speeds in a mixed memory module configuration. As discussed above, computing devices can be used to execute various applications and programs. A computing device may include memory modules. The memory modules allocate memory to execute various applications on the computing device. The more memory the computing device has, the more applications the computing device can execute simultaneously. Different memory modules can execute at different speeds, which can affect the performance of the computing device.

Currently, when two different memory modules are installed in a memory bus, a mixed memory module configuration may occur. When a mixed memory module configuration is detected by the computing device, the computing device may automatically default to a lower memory speed to avoid conflicts or errors in booting up the computing device. However, the lower memory speed may be significantly lower than the maximum speed of one or more of the memory modules that are installed.

The present disclosure provides a modification to a basic input/output system (BIOS) of the computing device to maximize the speeds of the memory modules in a mixed memory module configuration. When the mixed memory module configuration is detected, the BIOS may attempt to train the memory modules at a higher speed or a speed of one of the memory modules. If the boot-up of the computing device is successful, the computing device may operate the mixed memory module configuration at the higher speed. If the boot-up fails, the BIOS may default back to the lower speed.

Thus, the computing device of the present disclosure may take advantage of higher memory speeds even when a mixed memory module configuration is detected. In addition, no hardware modifications are need to implement the higher memory speeds.

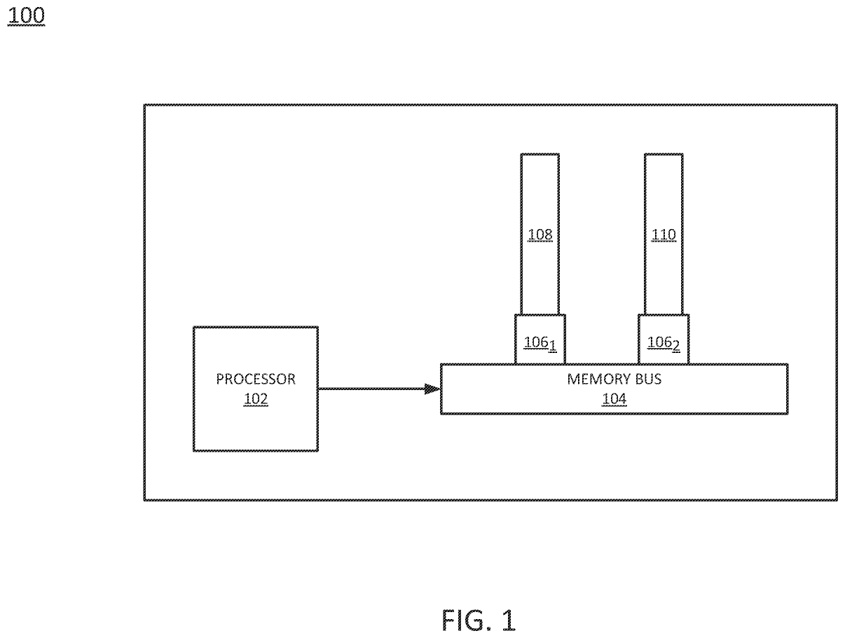

FIG. 1 illustrates an example computing device 100 of the present disclosure. In an example, the computing device 100 may be a desktop computer, a laptop computer, a tablet computer, and the like.

It should be noted that computing device 100 has been simplified for ease of explanation. Although various example components are illustrated in FIG. 1, it should be noted that the computing device 100 may include additional components that are not shown. For example, the computing device 100 may include input/output devices (e.g., a display, a monitor, a keyboard, a mouse, a trackpad, and the like), a power supply, various interfaces (e.g., a universal serial bus (USB) interface), communications interfaces (e.g., a wired or wireless communication interface such as WiFi, Ethernet, and the like), a solid state drive, a hard disk drive, a read-only memory (ROM), and so forth.

In an example, the computing device 100 may include a processor 102 and a memory bus 104. The processor 102 may be communicatively coupled to the memory bus 104 and may control operation of the memory bus 104.

The memory bus 104 may include a slot 106₁ and a slot 106₂. Although two slots are illustrated in FIG. 1, it should be noted that any number of slots may be deployed with the memory bus 104.

A first memory module 108 may be connected to the slot 106₁ and a second memory module 110 may be connected to the slot 106₂. The first memory module 108 and the second memory module 110 may be random access memory (RAM) sticks that can provide memory access to allow the processor to execute the operating system of the computing device 100 as well as other applications.

In an example, when the first memory module 108 and the second memory module 110 are not identical or have at least one different characteristic, a mixed memory module configuration may be detected by the processor 102. As discussed above, when a mixed memory module configuration is detected, previous computing devices would train the memory bus 104 to operate at a lowest or minimum memory speed even if both the first memory module 108 and the second memory module 110 were capable of operating at higher speeds. For example, the first memory module 108 may be capable of operating at 3600 megahertz (MHz) speeds, and the second memory module 110 may be capable of operating at 4000 MHz speeds. However, previous computing devices may train the memory bus 104 to operate at 2000 MHz to ensure that the memory modules operate correctly and that the operating system can be booted up without any errors.

The present disclosure may attempt to train the memory bus 104 to operate at a highest or maximum mixed memory module configuration speed initially. The processor 102 may attempt to boot the operating system at the maximum mixed memory module configuration speed. If no errors are detected, the processor 102 may continue. If errors are detected, the processor 102 may reset the computing device 100 and retrain the memory bus 104 to operate at the lowest or minimum memory speed.

In an example, the highest or maximum mixed memory module configuration speed may be the lower speed of the first memory module 108 and the second memory module 110. For example, if the first memory module 108 can operate at speeds up to 3600 MHz, and the second memory module 110 can operate at speeds up to 4000 MHz, the first memory module 108 would have the lower speed of the two memory modules. Thus, the highest mixed memory module configuration speed may be set to 3600 MHz.

In an example, the highest or maximum mixed memory module configuration speed may be predefined. For example, the predefined memory speed may be a speed that is determined to be compatible with most memory modules. For example, the predefined memory speed may be 3200 MHz.

In an example, the lowest or minimum memory speed may be the previously used memory speed of 2000 MHz. Thus, if the processor 102 can boot the operating system with the memory bus 104 trained to 3200 MHz, the computing device 100 may operate with the memory bus 104 at 3200 MHz speeds. However, if the operating system cannot boot successfully, the processor 102 may set the memory bus 104 to the lowest memory speed of 2000 MHz and reboot the operating system.

In an example, the characteristics that can cause the mixed memory module configuration can include a variety of different characteristics. For example, the characteristics may include a memory speed of the memory modules, a memory rank of the memory modules, a manufacturer of the memory modules, a memory size of the memory modules, and the like.

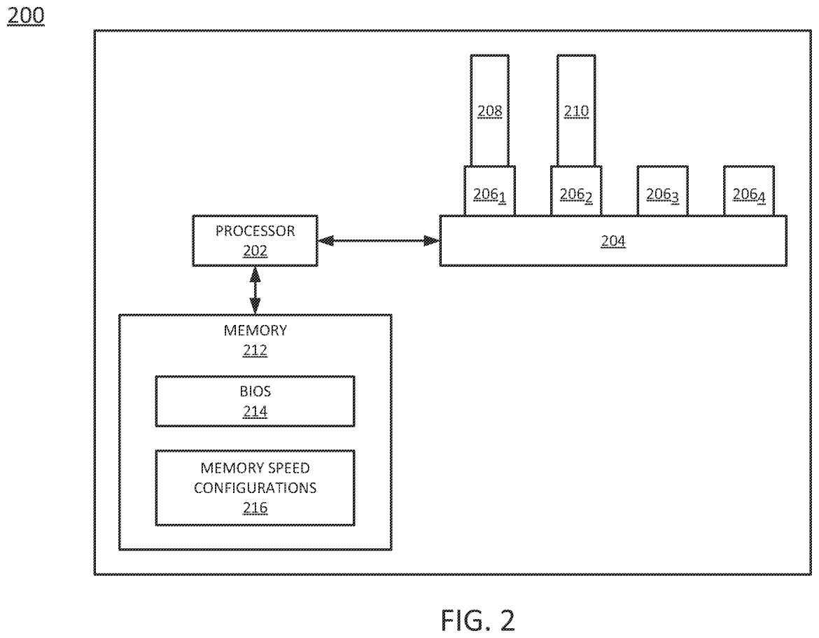

FIG. 2 illustrates another block diagram of another example computing device 200 to maximize speeds in a mixed memory module configuration of the present disclosure. The computing device 200 may include a processor 202, a memory bus 204, and a memory 212. The processor 202 may be communicatively coupled to the memory bus 204 to control operation of the memory bus 204. The processor 202 may be communicatively coupled to the memory 212 to execute instructions stored in the memory 212 to perform the functions described herein.

In an example, the memory bus 204 may be a dual in-line memory module (DIMM) memory bus. The memory bus 204 may include four memory slots 206₁-206₄. Although four slots are illustrated in FIG. 2, it should be noted that the present disclosure may be applied to any type of memory bus with any number of slots.

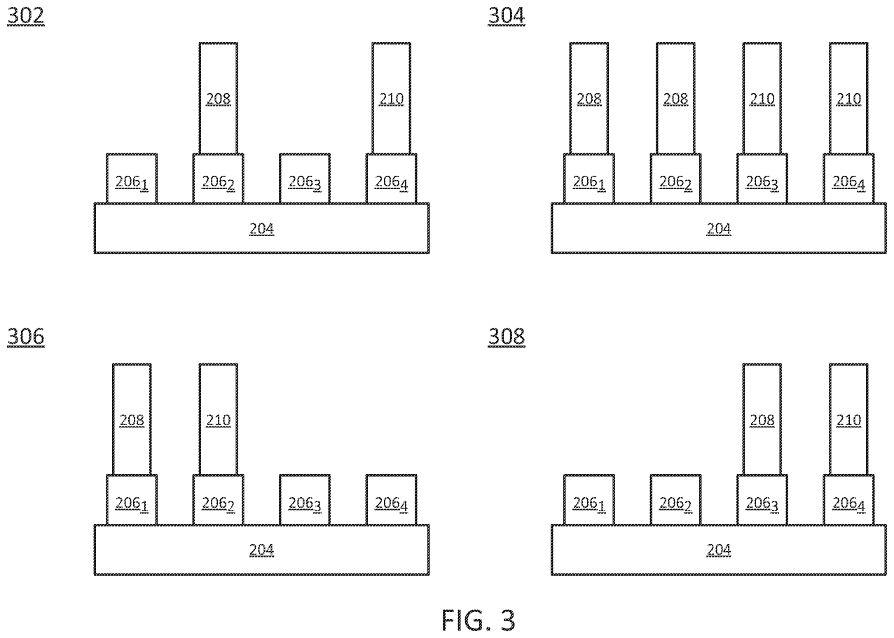

In an example, the slots 206₁ and 206₂ may be associated with a first memory channel and the slots 206₃ and 206₄ may be associated with a second memory channel. Thus, each channel of the memory bus 204 may control or operate two separate memory modules. FIG. 3 illustrates various example configurations of memory modules and which configurations cause a mixed memory module configuration and which configurations are valid, and is discussed in further details below.

FIG. 2 illustrates an example, where a first memory module 208 is connected to the slot 206₁ and a second memory module 210 is connected to the slot 206₂. The first memory module 208 and the second memory module 210 are different. In other words, at least one characteristic is different between the first memory module 208 and the second memory module 210, as described above. As a result, the processor 202 may detect a mixed memory module configuration in the first channel of the memory bus 204 that includes slots 206₁ and 206₂.

In an example, the memory 212 may include any type of non-transitory computer readable medium. The memory 212 may be hard disk drive, a read-only memory (ROM), a solid state drive, a non-volatile memory express (NVMe) drive, and the like. The memory 212 may store a basic input/output system (BIOS) 214 and memory speed configurations 216. The memory 212 may store other information that is not shown. For example, the memory 212 may store the operating system as well as any other applications that can be executed by the processor 202.

In an example, the BIOS 214 may be used to train the operating speed of the memory bus 204 before the operating system is booted. For example, when the computing device 200 is powered on, the processor 202 may detect the mixed memory module configuration and execute the BIOS 214 to train the memory bus 204 to the highest or maximum mixed memory module configuration speed, as discussed above.

In an example, the BIOS 214 may have a timer and a counter. The counter may be set to a value of 1 to ensure that the BIOS 214 makes a single attempt to train the memory bus 204 at the maximum mixed memory module configuration speed. In other words, if the operating system fails to boot at the maximum mixed memory module configuration speed, then the BIOS 214 may retrain the memory module 204 to the minimum mixed memory module configuration speed to ensure that the operating system will boot successfully, rather than indefinitely trying and failing to boot the operating system at the maximum mixed memory module configuration speed.

In an example, the timer may limit how long the BIOS 214 waits to see if the operating system can successfully boot at the maximum mixed memory module configuration speed. For example, the timer may be set to 30 seconds, 1 minute, and the like. If the timer expires before the operating system boots, then the BIOS 214 may assume that the operating system has failed to boot. The BIOS 214 may then restart the computing device 200 and retrain the memory bus 204 to the minimum mixed memory module configuration speed to ensure that the operating system boots successfully.

As used herein, a BIOS refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of the computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, the memory speed configurations 216 may store the maximum mixed memory module configuration speed and the minimum mixed memory module configuration speed. As discussed above, the maximum mixed memory module configuration speed may be the lower speed of the first memory module 208 or the second memory module 210 or may be predefined (e.g., 3200 MHz). The minimum mixed memory module configuration speed may be predefined (e.g., 2000 MHz).

As noted above, FIG. 3 illustrates different example configurations of the first memory module 208 and the second memory module 210 in the memory bus 204. As noted above, the memory bus 204 may be a DIMM memory bus that includes two channels. The slots 206₁ and 206₂ may be part of the first channel, and the slots 206₃ and slot 206₄ maybe part of the second channel.

In example configuration 302, the first memory module 208 is in the slot 206₂ and the second memory module 210 is in the slot 206₄. This would be a valid configuration that would allow the first memory module 208 and the second memory module 210 to operate at their respective highest capable speeds. Since each channel can be operated separately, the example configuration 302 would not cause a mixed memory module configuration.

In example configuration 304, a pair of first memory modules 208 is connected to the slots 206₁ and 206₂ and a pair of second memory modules 210 is connected to the slots 206₃ and 206₄. The example configuration 304 would also be valid because each channel includes a pair of identical memory modules. In other words, no mixed memory module configuration would be detected in the example configuration 304.

In example configuration 306, a first memory module 208 is connected to the slot 206₁ and a second memory module 210 is connected to the slot 206₂. This would cause a mixed memory module configuration, as described above in FIG. 2.

In example configuration 308, a first memory module 208 is connected to the slot 206₃ and a second memory module 210 is connected to the slot 206₄. The example configuration 308 would also cause a mixed memory module configuration because the first memory module 208 and the second memory module 210 are different and are connected to different slots of the same channel on the memory bus 204.

Thus, the present disclosure may modify the operation of the BIOS and the boot sequence to train the memory bus 104 or 204 to operate at higher speeds when a mixed memory module configuration is detected. Rather than operating at an artificially low speed out of caution, the BIOS can be modified to attempt to train the memory bus 104 or 204 at a higher memory speed initially when the mixed memory module configuration is detected.

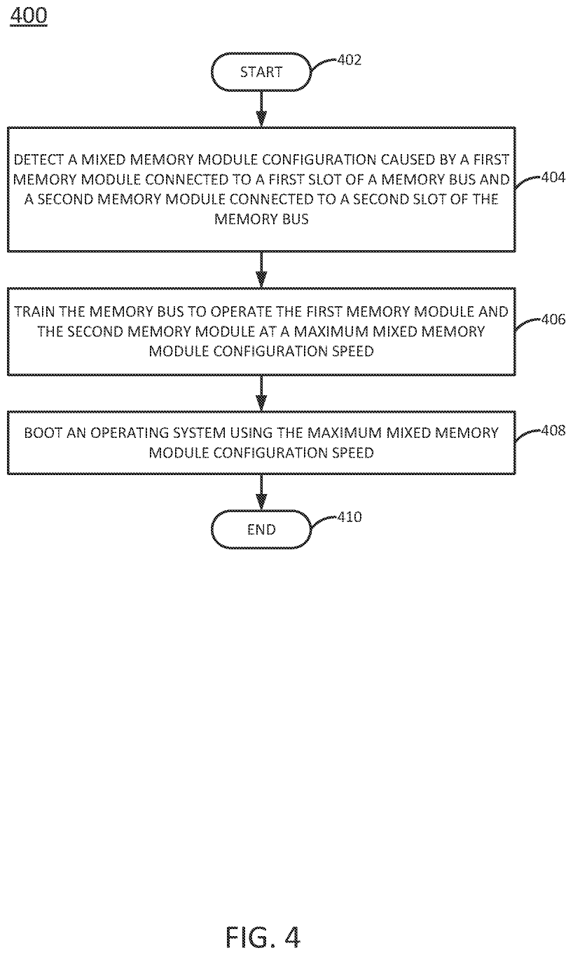

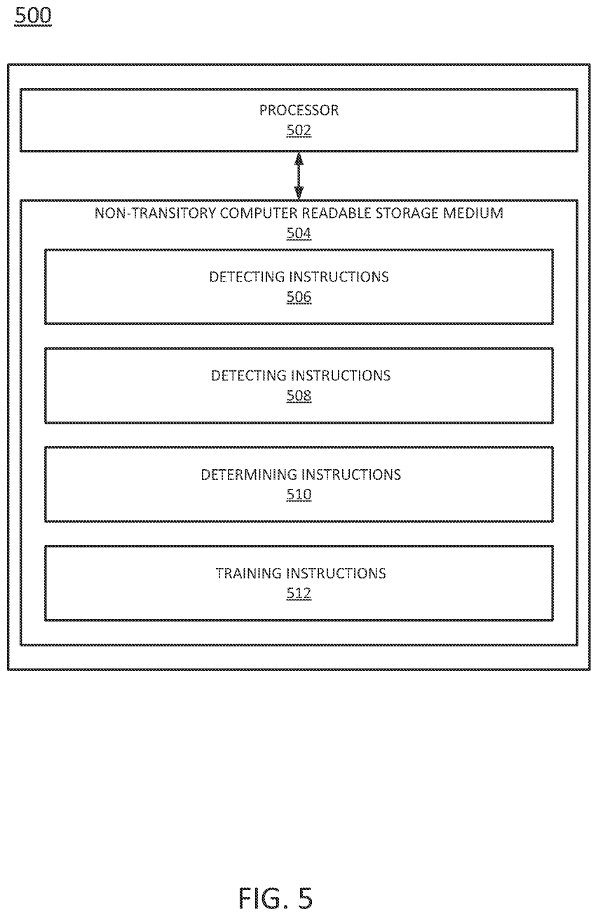

FIG. 4 illustrates a flow diagram of an example method 400 for maximizing speed in a mixed memory module configuration of the present disclosure. In an example, the method 400 may be performed by the computing device 100 illustrated in FIG. 1, the computing device 200 illustrated in FIG. 2, or the apparatus 500 illustrated in FIG. 5, and described below.

At block 402, the method 400 begins. At block 404, the method 400 detects a mixed memory module configuration caused by a first memory module connected to a first slot of a memory bus and a second memory module connected to a second slot of the memory bus. For example, the first slot and the second slot may be associated with a same channel of a DIMM memory bus.

The mixed memory module configuration may be caused by a mismatch in the first memory module and the second memory module. For example, the first memory module and the second memory module may not be identical. The mismatch may be caused by at least one different characteristic. The at least one different characteristic may be a different memory speed, a different memory rank, a different manufacturer, a different memory size, and the like.

At block 406, the method 400 trains the memory bus to operate the first memory module and the second memory module at a maximum mixed memory module configuration speed. For example, the maximum mixed memory module configuration speed may be a lower speed of the first memory module and the second memory module. In another example, the maximum mixed memory module configuration speed may be predefined (e.g., 3200 MHz).

In an example, the memory bus may be trained by a BIOS of the computing system during a boot sequence. For example, the computing device may be powered on. During the boot sequence the mixed memory module configuration may be detected, and the BIOS may train the memory bus to operate at the maximum mixed memory module configuration speed.

At block 408, the method 400 boots an operating system using the maximum mixed memory module configuration speed. In an example, the BIOS may set a counter to a value of 1 and set a timer to a predefined time limit (e.g., 30 seconds). The counter may ensure that the BIOS makes a single attempt to boot the operating system with the memory bus trained at the maximum mixed memory module configuration speed.

The timer may limit how long the BIOS waits before restarting the computing device to retrain the memory bus to the minimum mixed memory module configuration speed. For example, if the timer expires before the operating system boots successfully, the BIOS may assume that the operating system has failed to boot and may restart the computing device. The BIOS may retrain the memory bus to operate the first memory module and the second memory module at the minimum mixed memory module configuration speed. The operating system may then be booted at the minimum mixed memory module configuration speed. At block 410, the method 400 ends.

FIG. 5 illustrates an example of an apparatus 500. In an example, the apparatus 500 may be the apparatus 100 or 200. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include detecting instructions 506. For example, the instructions 506 may detect a first memory module connected to a first slot of a memory bus. The memory bus may be a DIMM memory bus. The first slot may be associated with a first channel of the DIMM memory bus.

The instructions 508 may include detecting instructions. For example, the instructions 508 may detect a second memory module connected to a second slot of the memory bus. The second slot may also be associated with the same first channel of the DIMM memory bus.

The instructions 510 may include determining instructions. For example, the instructions 510 may determine that at least one characteristic of the first memory module is different from the second memory module. For example, the first memory module and the second memory module may be mismatched and connected to different slots of the same channel in the DIMM memory bus. The mismatch may cause a mixed memory module configuration.

The instructions 512 may include training instructions. For example, the instructions 512 may train the first memory module and the second memory module to operate at a maximum mixed memory module configuration speed during boot-up of the computing device.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing device, comprising:
a memory bus;
a first memory module connected to a first slot of the memory bus;
a second memory module connected to a second slot of the memory bus; and
a processor communicatively coupled to the memory bus, wherein the processor is to:
detect a mixed memory module configuration caused by the first memory module and the second memory module; and
train the first memory module and the second memory module to operate at a maximum mixed memory module configuration speed.

2. The computing device of claim 1, wherein the memory bus comprises a dual in-line memory (DIMM) module bus.

3. The computing device of claim 1, wherein the mixed memory module configuration is caused by the first memory module and the second memory module having different memory speeds.

4. The computing device of claim 1, wherein the mixed memory module configuration is caused by the first memory module and the second memory module being manufactured by different manufacturers.

5. The computing device of claim 1, wherein the mixed memory module configuration is caused by the first memory module and the second memory module having different memory sizes.

6. The computing device of claim 1, wherein the mixed memory module configuration is caused by the first memory module and the second memory module having different memory ranks.

7. The computing device of claim 1, further comprising:
a basic input/output system (BIOS) to train the first memory module and the second memory module during a boot sequence.

8. The computing device of claim 1, wherein the maximum mixed memory module configuration speed comprises 3200 megahertz (MHz).

9. A method, comprising:
detecting, by a processor of a computing device, a mixed memory module configuration caused by a first memory module connected to a first slot of a memory bus and a second memory module connected to a second slot of the memory bus;
training, by the processor, the memory bus to operate the first memory module and the second memory module at a maximum mixed memory module configuration speed; and
booting, by the processor, an operating system using the maximum mixed memory module configuration speed.

10. The method of claim 9, further comprising:
determining, by the processor, that the operating system failed to boot;
training, by the processor, the memory bus to operate the first memory module and the second memory module at a minimum mixed memory module configuration speed in response to the determining; and
booting, by the processor, the operating system at the minimum mixed memory module configuration speed.

11. The method of claim 10, wherein the minimum mixed memory module configuration speed comprises 2000 megahertz (MHz).

12. The method of claim 9, wherein the maximum mixed memory module configuration speed comprises a speed of the first memory module or the second memory module.

13. The method of claim 9, wherein the maximum mixed memory module configuration speed comprises 3200 megahertz (MHz).

14. The method of claim 9, wherein the detecting, the training, and the booting are performed by a basic input/output system (BIOS) of the computing device that is controlled by the processor when the computing device is powered on.

15. The method of claim 9, wherein the mixed memory module configuration is caused by a mismatch between the first memory module and the second memory module.

16. A non-transitory computer readable storage medium encoded with instructions which, when executed, cause a processor of a computing device to:
detect a first memory module connected to a first slot of a memory bus;
detect a second memory module connected to a second slot of the memory bus;
determine that at least one characteristic of the first memory module is different from the second memory module; and
train the first memory module and the second memory module to operate at a maximum mixed memory module configuration speed during boot-up of the computing device.

17. The non-transitory computer readable storage medium of claim 16, wherein the at least one characteristic comprises a memory speed, a memory size, a manufacturer, or a memory rank.

18. The non-transitory computer readable storage medium of claim 16, wherein the instructions cause the processor further to:
limit a counter to one;
detect that the boot-up of the computing device failed; and
train the first memory module and the second memory module to operate at a minimum mixed memory module configuration speed in response to the boot-up of the computing device having been detected to fail.

19. The non-transitory computer readable storage medium of claim 18, wherein the instructions cause the processor further to:
set a timer, wherein failure of the boot-up of the computing device is detected when the computing device fails to boot-up before expiration of the timer.

20. The non-transitory computer readable storage medium of claim 16, wherein the maximum mixed memory module configuration speed comprises 3200 megahertz (MHz).
